(19) United States
(12) Patent Application Publication
(10) Pub. No.: US 2006/0059036 A1
(43) Pub. Date: Mar. 16, 2006

(54) Method and system for managing a supply chain of a commodity class

(76) Inventors: Stephen Anton Moese, West Chester, OH (US); Matthew Eric Unger, Maineville, OH (US); Jerome Arthur Riesenberg, Oxford, OH (US); Michael Herbert Brock, Loveland, OH (US)

Correspondence Address: DINSMORE & SHOHL, LLP, 1900 CHEMED CENTER, 255 EAST FIFTH STREET, CINCINNATI, OH, 45202, US

(21) Appl. No.: 10/943,114

(22) Filed: Sep. 16, 2004

(51) Int. Cl. G07G 1/00

(52) U.S. Cl. 705/10

(57) ABSTRACT

A method of managing a supply chain of a commodity class includes inputting one or more performance measures for a selected member of the commodity class into a data store; inputting one or more characteristics of the selected member into the data store; comparing the one or more characteristics of the selected member with characteristics of a base member of the commodity class to determine one or more deviation characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

### FIELD OF THE INVENTION

The present invention relates to a method and system for managing a supply chain of a commodity class, and more specifically to a unique method and system for analyzing the cost drivers and performance measures of a selected member of the commodity class to improve management of the supply chain.

### BACKGROUND OF THE INVENTION

The virtual explosion of technical advances in microelectronics, digital computers and software have changed and continue to change the face of modern society. In fact, these technological advances have become so important and pervasive that this explosion is sometimes referred to as “the information revolution.” Through telephone lines, networks, satellite and other wireless communications and the like, information and resources are ever increasingly being accessed and shared.

Raw material spend analysis is a common feature of many available Project Lifecycle Management (PLM) tools. By making common materials known to all parts of a business using them, an enterprise can create scale opportunities for its buyers. Larger orders from fewer suppliers typically helps drive costs down. These PLM management approaches are typically limited to actual materials purchased and dollars spent. Additionally, typical PLM tools do not manage common material differences adequately as they typically have no ability to associate materials within a common family for aggregation and/or substitution analysis, or provide any insight for defining why a selected material costs as it does.

The United Nations Standard Products and Services Code®) (UNSPSC®) provides an open, global multi-sector standard for classification of products and services. The UNSPSC® is an industry coding system dedicated to Raw Material Classification. UNSPSC® is proposed as a uniform way to define spend pools or material groups for the purposes of managing internal cost accounting. Additional benefits accrue to UNSPSC® users as the Dunn & Bradstreet database links UNSPSC® codes to known suppliers and company profiles. This linking helps both procurement groups and research and development groups identify potential sources in support of expanding business or innovation initiatives. However, UNSPSC® does not allow identification of key cost creation steps supporting the price charged by a supplier.

Typically, many materials in an enterprise are purchased by trade name or description only. This creates difficulty in determining available substitution products and suppliers. Without substitution, there is much less leverage available to a buyer to foster competition aimed at lowering prices. As such, it is typically desired to specify raw materials based on performance measures. Selection of the right performance measures helps ensure compliance with product design, manufacturability, safety and legal requirements. It is often difficult, however, due to cost and time factors, for a purchasing enterprise to determine these performance measures; conversely, a supplier typically has access to such performance measures. Accordingly, improvements to the methods and systems for management of a supply chain of products are desired.

### SUMMARY OF THE INVENTION

The present invention is directed to methods and systems of managing a supply chain of a commodity class. More particularly, the invention is directed to methods and systems which determine one or more cost drivers based on deviation characteristics of the selected member of the commodity class from the base member characteristics.

One embodiment of the present invention is a method of managing a supply chain of a commodity class. The method comprises: inputting one or more performance measures for a selected member of the commodity class into a data store; inputting one or more characteristics of the selected member into the data store; comparing the one or more characteristics of the selected member with characteristics of a base member of the commodity class to determine one or more deviation characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

Another embodiment of the present invention is a system for managing a supply chain of a commodity class, comprising: a user interface, and a supply chain module in communication with a data store and the user interface. The supply chain module comprises executable instructions for analyzing the commodity class supply chain based on cost drivers and performance measures.

A further embodiment of the present invention is a storage medium with machine-readable computer program code for managing a supply chain of a commodity class. The storage medium includes instructions for causing a computer to implement a method which comprises: inputting one or more performance measures for a selected member of the commodity class into a data store; inputting one or more characteristics of the selected member into the data store; comparing the one or more characteristics of the selected member with characteristics of a base member of the commodity class to determine one or more deviation characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

Another embodiment of the present invention is a computer data signal embodied in a carrier wave and representing sequences of instructions which, when executed by a processor, provide management of a supply chain commodity class. The signal comprises the instructions for: inputting one or more performance measures for a selected member of the commodity class into a data store; inputting one or more characteristics of the selected member into the data store; comparing the one or more characteristics of the selected member with characteristics of a base member of the commodity class to determine one or more deviations characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

The present methods and systems are advantageous for providing management of a supply chain of a commodity class.

### BRIEF DESCRIPTION OF THE DRAWINGS

While the specification concludes with claims particularly pointing out and distinctly claiming the invention, it is believed the same will be better understood from the following description taken in conjunction with the accompanying drawings in which:

FIG. 1 depicts a flowchart of an exemplary method for managing a supply chain of a commodity class according to a first embodiment of the present invention;

FIG. 2 depicts a flowchart of an exemplary method for managing a supply chain of a commodity class according to a second embodiment of the present invention;

FIG. 3 depicts a flowchart of an exemplary method for managing a supply chain of a commodity class according to a third embodiment of the present invention;

FIG. 4 is a schematic illustration of an exemplary system for managing a supply chain of a commodity class according to a fourth embodiment of the present invention;

FIGS. 5A & 5B depict exemplary performance measures of a commodity class according to a fifth embodiment of the present invention;

FIG. 6 depicts an exemplary user interface for inputting characteristics of a member of the commodity class according to a sixth embodiment of the present invention; and

FIG. 7 depicts an exemplary client/server network according to a seventh embodiment of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE INVENTION

Reference will now be made in detail to various embodiments of the invention, examples of which are illustrated in the accompanying drawings, wherein like numerals indicate similar elements throughout the views.

The phrase “commodity class” as used herein refers to a class of raw materials, processed materials, or products utilized by an enterprise. Examples of commodity classes would include stretch films, flexible packaging, carton board packaging, rigid packaging, paper, surfactants, solvents, nonwoven fabrics, perfumes, flavorants, acidulants, alcohols, alkalis, sweeteners, polymers, sand, iron ore, steel, lumber, glass, corn, rice, beef, pork, potatoes, and many more.

The phrase “selected member” as used herein refers to an individual article, material, part or product or a subset of articles, materials, parts and/or products of the commodity class that is being analyzed to improve the overall management of the supply chain of the commodity class.

The phrase “base member” as used herein refers to a pre-determined member of the commodity class of which other members will be compared against. In one embodiment, the base member may comprise the simplest form of the commodity class, such as a basic polyethylene film for commodity classes comprising films. In another embodiment, the base member may comprise a more complex member of the commodity class routinely utilized by the enterprise. The base member is utilized to establish a basis for the comparisons and analysis of the method and system.

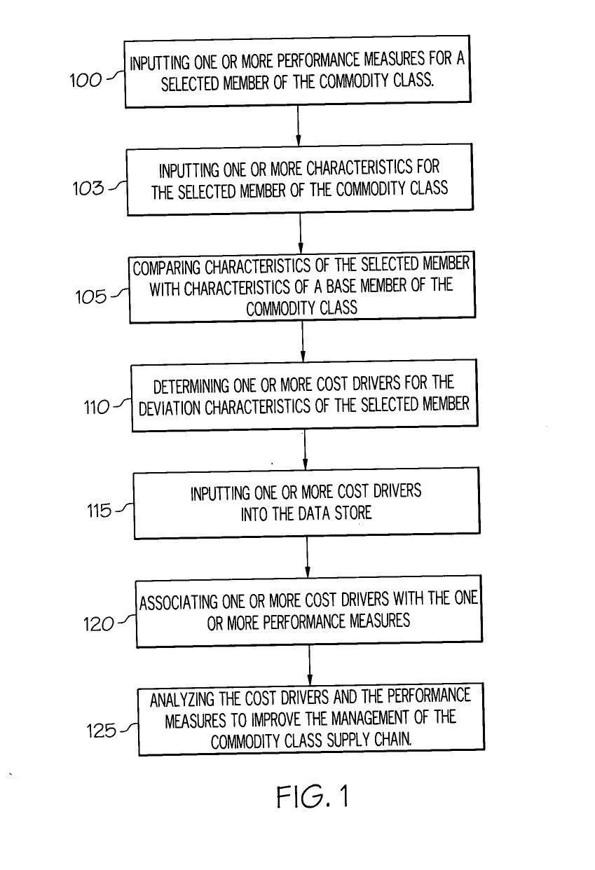

One embodiment of the present invention is a method of managing a supply chain of a commodity class. An illustrative flowchart of the method is depicted in FIG. 1. The method comprises: inputting one or more performance factors for a selected member of the commodity class into a data store (100); inputting one or more characteristics of the selected member into the data store (103); comparing characteristics of the selected member with characteristics of a base member of the commodity class to determine one ore more characteristics of the selected member (105); determining one or more cost drivers for the deviation characteristics of the selected member (110); inputting the one or more cost drivers into the data store (115); associating the one or more cost drivers with the one or more performance measures (120); and analyzing the cost drivers and performance measures to improve the management of the commodity class supply chain (125).

Many analytical approaches are possible, including averaging, summing, standard deviation, variance, regression, clustering, analysis of variance, among others. All have their particular uses. This embodiment enables the exact definition of the data subset to be analyzed with particular attention to cost drivers and performance measures that characterize a material.

Material class members may be grouped by performance, cost, application, source, production process, supplier, geographical location, features, treatments, or other means consistent with the objectives of the analysis. This embodiment enables selecting a subset of materials based on cost or a key descriptor of interest and establishing the optimum performance and cost based on known materials. Thus in one approach, the practitioner would view hundreds of materials and choose a performance band desired, and then rank the materials by value. The best value material would have certain cost drivers associated with it that can then be compared with materials of interest in a way that can change the cost profile of more expensive options.

Alternatively, the practitioner might look to the suppliers of a given material, and based on the applicable cost drivers determine a more efficient material selection that enables lower costs to both firms. Similarly, a business unit in one region can identify materials for reapplication from the materials in use in another region and or business. This speeds market introduction by shortening supply development, enabling import/export of materials, or and reducing uncertainties associated with new material developments. Additionally, analyses such as cluster analyses to identify key groups for further study, and Analysis of Variance (ANOVA) can be performed on large lists of materials to define the impact of each cost driver for a large set of materials.

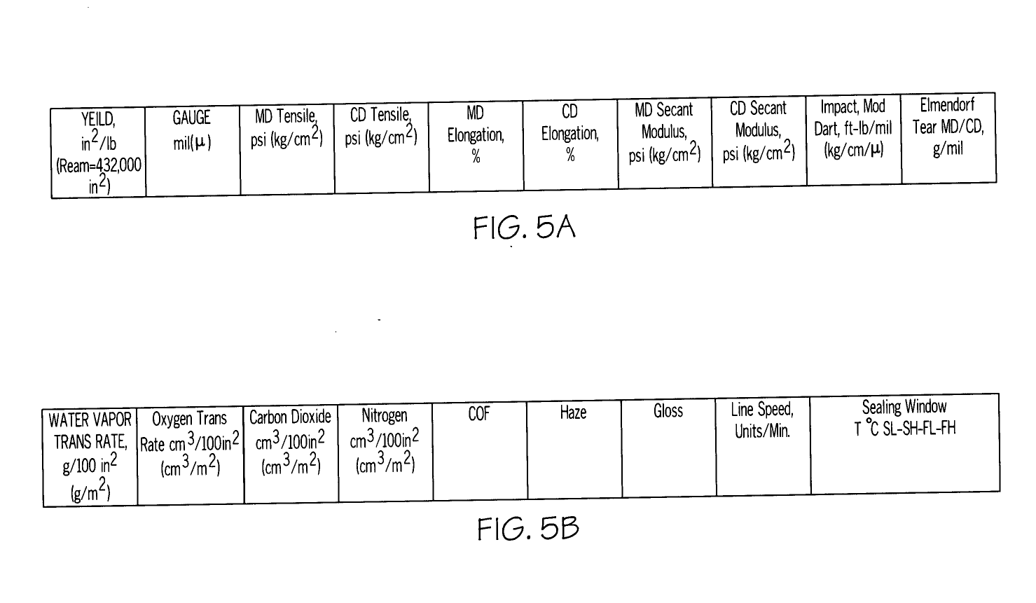

In one exemplary embodiment, the performance measures comprise analytical testing data and physical properties for the selected member of the commodity class. These performance measures can be obtained from a supplier of the selected member of the commodity class, can be determined by a third-party testing organization, or can be determined by the enterprise itself. Some exemplary performance measures for a commodity class comprising films are illustrated in FIGS. 5A and 5B. Exemplary performance measures for the film commodity class, include but are not limited to: gauge, caliper/thickness, web width, core size, roll diameter, roll length, roll weight, Elmendorf Tear Strength, Cling, coefficient of friction, force required to stretch 200%, load force at 200%, elongation, tensile ultimate, tensile break, impact strength, haze gloss, unitizing, and the like.

In another exemplary embodiment, the characteristics of the selected member of the commodity class which are used for comparison with a base member comprise composition, production steps, treatments, appearance options, and/or structural or material form. For example, the base member of the commodity class may comprise a linear low density polyethylene (composition) film which is blown extruded (production steps) and laminated (production steps) with low density polyethylene (composition) films. Performance measures describe the performance properties of the member of the commodity class, whereas characteristics describe the origination, production and treatment of the member of the commodity class which helps the member yield the performance measures.

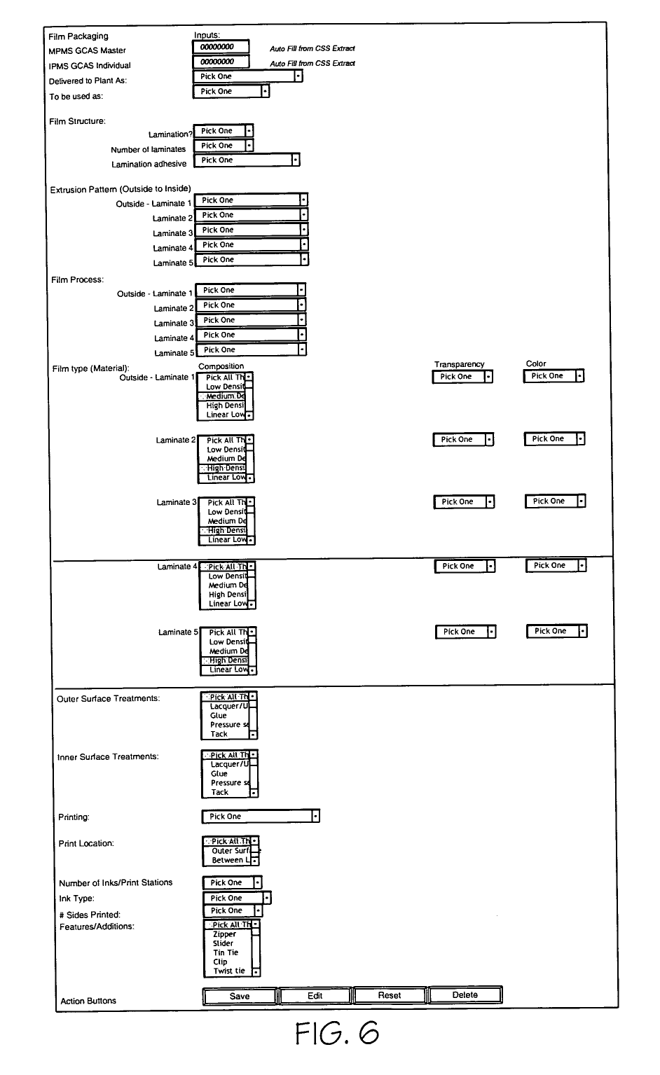

An exemplary user interface for inputting one or more characteristics of the selected member into a data store is depicted in FIG. 6. As illustrated by the exemplary embodiment in FIG. 6, the selected member is from the film packaging commodity class. The film packaging commodity class is classified by the film structure, extrusion pattern, film process, film type, outer surface treatments, inner surface treatments, printing, print location, number of inks, ink type, number of sides printed and additional features of the selected member. The inputted characteristics of the selected member can them be compared against the base member of the commodity class to determine one or more deviation characteristics of the selected member, i.e. with respect to the base member, and the cost drivers of the deviation characteristics are determined. Specifically, the cost drivers are the costs associated with the provision of the respective deviation characteristics. In an alternative embodiment, the characteristics of the selected material are obtained from patent literature, supplier trade publications, equipment manufactures, product specifications, and the like.

In one exemplary embodiment, the cost drivers are matched to key performance measures. In another embodiment of the present invention, the act of analyzing the cost drivers and performance measures further comprises determining alternative members of the commodity class with a predefined percentage of matching performance measures. For example, in one embodiment, a user can utilize the method to determine an alternative film having 80% matching key performance factors. This act is beneficial to users in efficiently identifying one or more alternative members, wherein the alternative members include one or more of the key desired performance measures. In another embodiment, the method further comprises identifying critical performance measures which must be contained in any analysis results of alternative members of the commodity class.

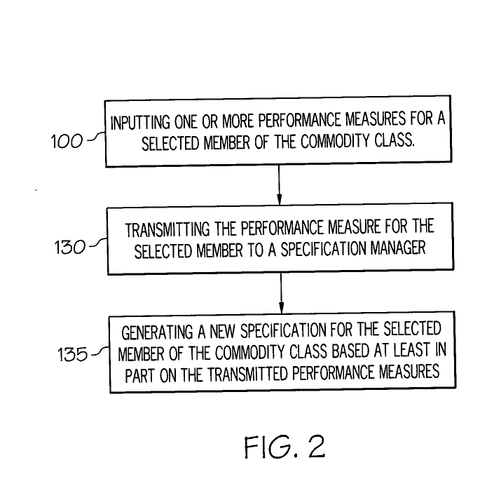

In yet another embodiment of the present invention, as depicted in FIG. 2, the method of managing a supply chain of a commodity class further comprises transmitting the performance measures for the selected member to a specification manager (130); and generating a new specification for the selected member of the commodity based at least in part on the transmitted performance measures (135). In a further embodiment, the newly generated specification is stored in the data store. In one embodiment, the specification manager is a human user who reviews the transmitted performance measures. In an alternative embodiment, the specification manager comprises a set of executable instructions for a processor for automatically developing a new specification from the transmitted performance measures.

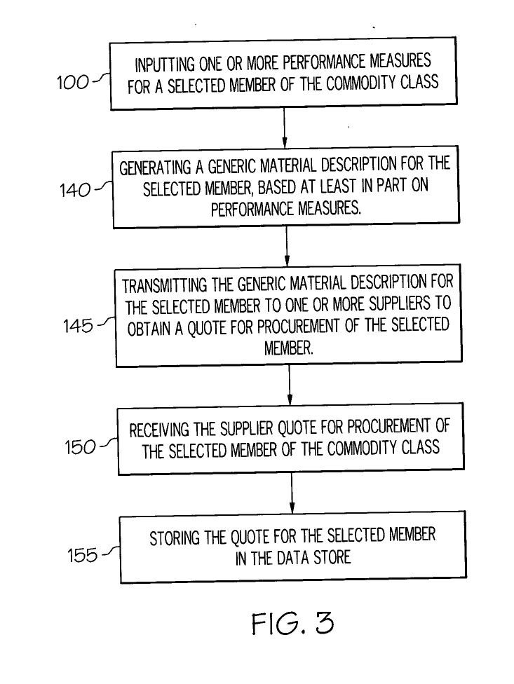

In another embodiment of the present invention, as depicted in FIG. 3, the method of managing a supply chain of a commodity class further comprises: generating a generic material description for the selected member, based at least in part on the performance measures (140); transmitting the generic material description for the selected member to one or more suppliers to obtain a quote for procurement of the selected member (145). The quote may contain identification of the product, the product's specification, the cost, availability, and shipment timing and costs. The method further comprises receiving from the supplier the quote for procurement of the selected member of the commodity class (150); and storing the quote for the selected member in the data store (155) for later analysis of the commodity class supply chain. In an alternative embodiment of the present invention, the suppliers are pre-approved suppliers who have been certified to submit quotes for the enterprise.

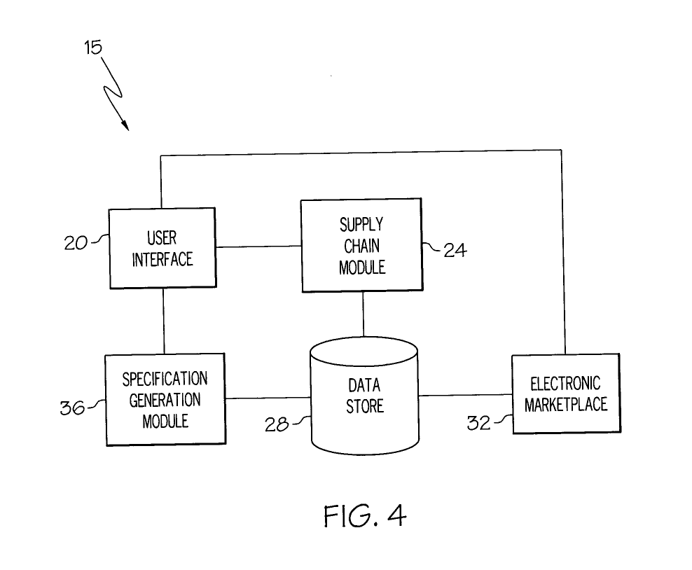

Another embodiment of the present invention, as illustrated in FIG. 4, is a system 15 for managing a supply chain. The system 15 comprises a user interface 20; and a supply chain module 24 in communication with a data store 28 and the user interface 20. The supply chain module 24 comprises executable instructions for analyzing the supply chain of a commodity class based on performance measures and cost drivers. The system may further comprise an electronic marketplace module 32 in communication with the data store 28 and the user interface 20, wherein the electronic marketplace module 32 comprises executable instructions for obtaining selected member quote information, alternative material suggestions and/or the procurement of the selected member. Further, the system may include a specification generation module 36 in communication with the data store 28 and the user interface 20, wherein the specification generation module 36 comprises executable instructions for assisting in the generation of a material specification for the selected member.

In one embodiment of the present invention, the data store 28 comprises a relational database system or a distributed directory such as Novell Directory Services (NDS). A relational database management system (RDBMS) is a computer database management system that uses relational techniques for storing and retrieving data. The relational techniques preferably comprise providing common fields, such as commodity class, performance measures, one or more characteristics, cost drivers, etc., for each entry in the database. These common fields allow comparison between different members of the commodity class. A relational system has the flexibility to take any two or more files and generate a new file from the records that meet the matching criteria. For example, an administrative user may desire a list of all members of a commodity class that have reached a tensile strength of 75 psi and are produced from a linear low density polyethylene material. A relational system allows this list to be easily created from the main relational database. Relational databases are computerized information storage and retrieval systems in which data in the form of tables are typically stored for use on disk drives or similar mass data stores. A “table” includes a set of rows spanning several columns. Each column in a table includes “restrictions” on the data contents thereof and may be designated as a primary or foreign key.

Often computers telecommunicate with each other and share information, applications and/or services. Sometimes in this setting, the various computers are referred to as nodes, which is a generic term referring to an access point in a interconnected system. One type of computer network employs a client/server architecture, wherein the portions of network applications that interact with human users are typically separated from the portions of network applications that process requests and information. Often, the portions of an application that interact with users or access network resources are called client applications or client software, and portions of an application that process requests and information are called server applications or server software. Client machines tend to run client software and server machines tend to run server software, however a server can be a “client” as well. In an exemplary embodiment of the invention, the user interface would be typically provided on a client machine (which might be any of the user interface alternatives contemplated and exemplified above such as a network computer, stand alone computer, interactive kiosk, etc.) and the software containing the computer instructions which comprise the methods according to the present invention would be located on a server computer, separate from the client machine.

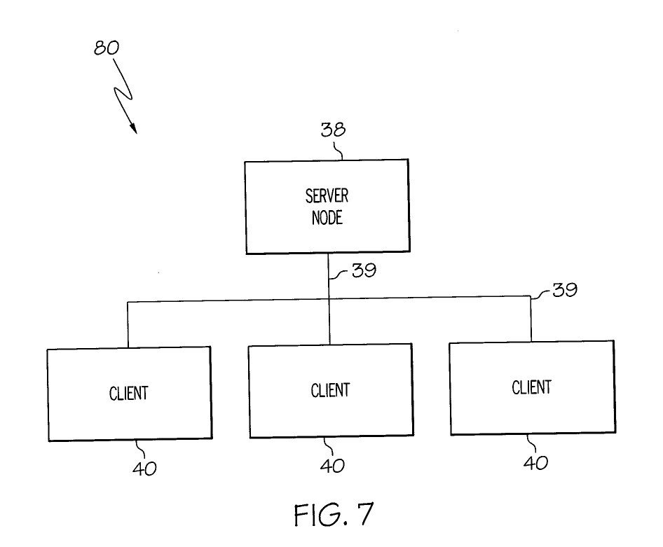

FIG. 7 schematically illustrates a sample client/server network 80 which might be employed to implement an embodiment of the present invention. As one with ordinary skill in the art will readily appreciate, a client/server network is only one type of network, and a variety of other configurations, such as peer-to-peer connections, are also considered networks. In a client/server network, a plurality of nodes are interconnected such that the various nodes send and/or receive information to/from one another. As shown here, a server node (38) is interconnected with a plurality of client nodes (40) using a connection (39) such as a token ring, Ethernet, telephone modem connection, radio or microwave connection, parallel cables, serial cables, telephone lines, universal serial bus “USB”, Firewire, Bluetooth, fiber optics, infrared “IR”, radio frequency “RF”, and the like, or combinations thereof.

In one exemplary embodiment, the user interface 20 might preferably comprise a kiosk, a computer, a personal digital assistant (PDA), a device with wireless application programs (WAP) such as cell phone, auto computer or PDA, interactive TV, or an Internet appliance, or the like. User interface 20 allows a user to communicate and interact with the system 15 and, as will be understood, can take any of a virtually unlimited number of alternative forms. In one exemplary embodiment, the user interface 20 may comprise a computer system comprising a CPU, memory, a visual display device and an input means. Exemplary input means comprise a keyboard or mouse or other means of input such as speech recognition and/or visual input utilizing a video camera. In another exemplary embodiment, the user interface 20 comprises a computer connected to the Internet through a communication link and running a web browser such as Internet Explorer from Microsoft Corp. or Netscape Navigator from Netscape Communications Corp.

In one embodiment, the web site is hosted on a network such as a wide-area network, local-area network, or the Internet, and the like. In one embodiment of the present invention, the connection between the user interface and the supply chain module of the system is a secure connection. Any secure connection technology may be employed as known to one skilled in the art. The Internet and World Wide Web operate on a client/server model and the user runs a web client, or browser, on a electronic device such as a computer, PDA, cell phone or television tuner, and the like. The web browser contacts a web server and requests data information, in the form of a Uniform Resource Locator (URL). This data information comprises the user interface of the interactive system of the present invention. Typically, URL addresses are typed into the browser to access web pages, and URL addresses are embedded within the pages themselves to provide the hypertext links to other pages. A hypertext link allows the user to click on the link and be redirected to the corresponding web site to the URL address of the hypertext link. Many browsers exist for accessing the World Wide Web, such as Netscape® Navigator from Netscape® and the Microsoft® Internet Explorer from Microsoft®. Similarly, numerous web servers exist for providing content to the World Wide Web, such as Apache™ from the Apache Group, Windows 2003 Server from Microsoft® Corp. Netscape Enterprise Server™ from Netscape® and Oracle® Web Application Server from Oracle® Corp. These browsers and web servers can be utilized to allow access to the present invention from virtually any web-accessible device.

Another embodiment of the present invention comprises a storage medium with machine-readable computer program code for managing a supply chain of a commodity class. The storage medium includes instructions for causing a computer to implement a method. The instructions may be for inputting one or more performance measures for a selected member of the commodity class into a data store; inputting one or more characteristics of the selected member into the data store; comparing the one or more characteristics of the selected member with characteristics of a base member of the commodity class to determine one or more deviation characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

In one exemplary embodiment, the storage medium comprises a computer-readable medium holds information readable by a computer, such as programs, data, files, etc. As will be readily appreciated, computer-readable medium can take a variety of forms, including magnetic storage (such as hard disk drives, floppy diskettes, etc.), optical storage (such as laser discs, compact discs, DVD's, etc.), electronic storage (such as random access memory “RAM”, read only memory “ROM”, programmable read only memory “PROM”, etc.), and the like.

Yet another embodiment of the present invention comprises a computer data signal embodied in a carrier wave and representing sequences of instructions which, when executed by a processor, provide management of a supply chain commodity class, the signal comprising the instructions: inputting one or more performance measures for a selected member of the commodity class into a data store; inputting one or more characteristics of the selected member into the data store; comparing the one or more characteristics of the selected member with characteristics of a base member of the commodity class to determine one or more deviation characteristics of the selected member; determining one or more cost drivers for the deviation characteristics of the selected member; inputting the one or more cost drivers into the data store; associating the one or more cost drivers with the one or more performance measures; and analyzing the cost drivers and performance measures to improve the management of the commodity class supply chain.

In one exemplary embodiment, the system and method are adapted to connect to one or more key platforms (such as a specification database for material technical information, a transaction database for order, shipping and billing data for a given material, a contract database for contract terms and expiration dates, and a price forecast database for future cost projections, none of which necessarily communicate or share information of any kind) in an enterprise and/or the ability to interact with one or more diagnostic tools such as SAS JMP™ or SAS spend analyzer™. The systems and methods of the present invention enable value analysis based on cost drivers and further enhance pricing and should cost estimates for a selected material. In one further embodiment, the system and method interact with real-time or quasi real-time data on one or more of the following: contract status, price forecasting, actual spend data, material specifications and the like. Quasi real-time data comprises data that is periodically uploaded to the system, but may not be instantaneously connected and updated to the system.

### EXAMPLE

Carton board is a common packaging material used by many businesses. In a large company with many business units, the use of this common material can be less than optimum. Carton board is typically sold by supplier brand with a modest level of technical performance information available. By requesting suppliers to provide a complete technical description of carton boards, along with the optimum classification of this material, the enterprise can better decide which board strength is appropriate for the intended application. Importantly by linking the performance information to the material cost from transaction data bases, the enterprise can define the current cost optimum. Additionally, the future projection for board cost (pulp cost) enable developing alternatives in time to maximize value from the market conditions. Moreover, where different products in different business units (not necessarily limited to the enterprise itself) use similar materials, the embodiment will identify the source and type of board with the best performance, best cost, or the best performance/cost ratio, regardless of region or application. The embodiment will also identify opportunities for combining otherwise disparate purchases to a common material and or a common supplier, increasing the amount purchased hence the volume base for the supplier(s) and reducing the cost to the enterprise.

All documents cited in the detailed description of the invention are, in relevant part, incorporated herein by reference; a citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of managing a supply chain of a commodity class, comprising:
inputting one or more performance measures for a selected member of the commodity class into a data store;
inputting one or more characteristics of the selected member into the data store; comparing the one or more characteristics of the selected member with characteristics of a base member of the commodity class to determine one or more deviation characteristics of the selected member;
determining one or more cost drivers for the deviation characteristics of the selected member;
inputting the one or more cost drivers into the data store;
associating the one or more cost drivers with the one or more performance measures; and
analyzing the cost drivers and performance measures to improve the management of the commodity class supply chain.

2. The method of claim 1, wherein analyzing the cost drivers and performance measures comprises determining alternative materials with substantially similar performance measures.

3. The method of claim 1, wherein analyzing the cost drivers and performance measures comprises determining alternative materials with substantially similar performance measures and lower cost drivers.

4. The method of claim 1, wherein analyzing the cost drivers and performance measures comprises predicting material cost based on cost drivers and performance measures stored in the data store.

5. The method of claim 1, wherein the characteristics comprise one or more factors selected from the group consisting of: composition, production method, treatments, appearance options, structural form, and material form.

6. The method of claim 1, wherein the performance measures comprise technical performance data.

7. The method of claim 1, further comprising:
transmitting the performance measures for the selected member to a specification manager;
generating a new specification for the selected member based at least in part on the transmitted performance measures.

8. The method of claim 1, further comprising:
transmitting the performance measures and the cost drivers for the selected member to a specification manager;
generating a new specification for the selected member based at least in part on the transmitted performance measures and cost drivers.

9. The method of claim 1, further comprising:
providing a purchasing interface to the data store, wherein the purchasing interface is adapted to provide real-time or quasi real-time purchasing data.

10. The method of claim 1, further comprising:
generating a generic material description for the selected member based at least in part on the performance measures;
transmitting the generic material description for the selected member to one or more suppliers to obtain a quote for production of the selected member;
receiving from the supplier the quote for the selected member; and
storing the quote for the selected member in the data store.

11. The method of claim 1, further comprising:
generating a generic material description for the selected member based at least in part on the performance measures;
transmitting the generic material description for the selected member to one or more suppliers to obtain an alternative product suggestion for the selected member;
receiving from the supplier the alternative product suggestion for the selected member; and
storing the alternative product suggestion for the selected member in the data store.

12. The method of claim 1, further comprising:
reviewing the performance measures for accuracy and consistency with terminology and units.

13. The method of claim 1, wherein the act of inputting one or more performance measures for a selected member of the commodity class into a data store comprises:
obtaining one or more performance measures for the selected member from a supplier of the selected member; and
inputting the one or more performance measures obtained from the supplier into the data store.

14. A system for managing a supply chain of a commodity class, comprising:
a user interface; and
a supply chain module in communication the user interface, wherein the supply chain module comprises executable instructions for analyzing the supply chain based on performance measures and cost drivers.

15. The system of claim 14, further comprising an electronic marketplace module in communication with a data store and the user interface, wherein the electronic marketplace module comprises executable instructions for obtaining information regarding one or more performance measures of a member of a commodity class, an alternative additional member of the commodity class and/or procurement information of a member of a commodity class.

16. The system of claim 14, wherein the electronic marketplace module is adapted to allow pre-approved vendors to interact with the system.

17. The system of claim 14, further comprising a specification generation module in communication with the data store and the user interface, wherein the specification generation module comprises executable instructions for assisting in the generation of a new specification for the selected member of the commodity class.

18. The system of claim 14, wherein the supply chain module comprises executable instructions for:
comparing characteristics of a selected member of the commodity class with characteristics of a base member of the commodity class to determine one or more deviation characteristics of the selected member; and
determining one or more cost drivers for the deviation characteristics of the selected material.

19. A storage medium with machine-readable computer program code for managing a supply chain of a commodity class, the storage medium including instructions for causing a computer to implement a method, comprising:
inputting one or more performance measures for a selected member of the commodity class into a data store;
inputting one or more characteristics of the selected member into the data store;
comparing the one or more characteristics of the selected member with characteristics of a base member of the commodity class to determine one or more deviation characteristics of the selected member;
determining one or more cost drivers for the deviation characteristics of the selected member;
inputting the one or more cost drivers into the data store;
associating the one or more cost drivers with the one or more performance measures; and
analyzing the cost drivers and performance measures to improve the management of the commodity class supply chain.

20. A computer data signal embodied in a carrier wave and representing sequences of instructions which, when executed by a processor, provide management of a supply chain commodity class, the signal comprising instructions for:
inputting one or more performance measures for a selected member of the commodity class into a data store;
inputting one or more characteristics of the selected member into the data store;
comparing the one or more characteristics of the selected member with characteristics of a base member of the commodity class to determine one or more deviation characteristics of the selected member;
determining one or more cost drivers for the deviation characteristics of the selected member;
inputting the one or more cost drivers into the data store;
associating the one or more cost drivers with the one or more performance measures; and
analyzing the cost drivers and performance measures to improve the management of the commodity class supply chain.
